(19) United States
(12) Patent Application Publication
(10) Pub. No.: US 2016/0200573 A1
(43) Pub. Date: Jul. 14, 2016

(54) ELECTROLYTIC WATER GENERATOR, ELECTROLYTIC WATER GENERATING METHOD AND ELECTROLYTIC WATER

(71) Applicant: KABUSHIKI KAISHA TOSHIBA, Tokyo (JP)

(72) Inventors: Masahiro YOKOTA, Fukaya Saitama (JP); Hideo OOTA, Tokyo (JP); Masaru NIKAIDO, Yokohama Kanagawa (JP); Hidemi MATSUDA, Toda Saitama (JP)

(21) Appl. No.: 15/057,418

(22) Filed: Mar. 1, 2016

Related U.S. Application Data
(63) Continuation of application No. PCT/JP2015/053578, filed on Feb. 10, 2015.

(30) Foreign Application Priority Data
Mar. 19, 2014 (JP) 2014-055917

(51) Int. Cl. C01B 5/00; C25B 15/08; C25B 9/18; C25B 1/00; C25B 9/06

(52) U.S. Cl. CPC C01B 5/00; C25B 1/00; C25B 9/06; C25B 9/18; C25B 15/08

(57) ABSTRACT

According to one embodiment, an electrolytic water generator includes a plurality of electrolytic cells configured to generate electrolytic water by energizing a pair of electrodes arranged in water to be electrolyzed. An inflow unit is configured to let the water to be electrolyzed flow in parallel. An inflow disconnecting unit is configured to individually disconnect the water to be electrolyzed flowing in parallel is provided in the inflow unit. An electrode disconnecting unit is configured to individually disconnect between the pair of electrodes is provided. Power is supplied with a constant current from a power source by connecting the pair of electrodes of the plurality of electrolytic cells in series through the electrode disconnecting unit.

### CROSS REFERENCE TO RELATED APPLICATIONS

This application is a Continuation application of PCT Application No. PCT/JP2015/053578, filed Feb. 10, 2015 and based upon and claiming the benefit of priority from Japanese Patent Application No. 2014-055917, filed Mar. 19, 2014, the entire contents of all of which are incorporated herein by reference.

### FIELD

Embodiments described herein relate generally to an electrolytic water generator, an electrolytic water generating method and electrolytic water.

### BACKGROUND

The technique of electrolyzing water to generate electrolytic water having various functions is utilized to generate alkali ion water, ozone water, hypochlorous acid water, etc. Some electrolytic water generator is used to generate the hypochlorous acid water and an aqueous sodium hydroxide solution. The hypochlorous acid water is utilized as sterilizing water, and the aqueous sodium hydroxide solution is utilized as cleaning water.

This electrolytic water generator often requires a triple-chamber electrolytic cell. The triple-chamber electrolytic cell places an anode chamber and a cathode chamber on both sides of a middle chamber containing salt water. The anode chamber is partitioned from the middle chamber by an anion-exchange membrane, and places an anodic electrode. Further, the cathode chamber is partitioned from the middle chamber by a cation exchange membrane, and places a cathodic electrode. The electrolytic water generator of the above structure in which the triple-chamber electrolytic cell is used puts salt water in the middle chamber, lets water flow into the anode chamber and the cathode chamber, and applies a direct voltage between an anode and a cathode. This produces gaseous chlorine in the anode chamber, and generates hypochlorous acid water from the gaseous chlorine. Also, this removes gaseous hydrogen from the water, and generates the aqueous sodium hydroxide solution in the cathode chamber.

Since the electrolytic water generator of the above structure has a single electrolytic cell, it needs to suspend the generation of the electrolytic water until the electrolytic cell is repaired when the cell has broken down. Further, a variety of amounts of electrolytic water generation are requested, and thus, electrolytic cells that can contain the requested largest amount of electrolytic water and piping equipment such as water-supply and water-discharge pipes need to be individually designed and manufactured.

### BRIEF DESCRIPTION OF THE DRAWINGS

FIG. 1 is a plan view showing a structure of an electrolytic water generator according to an embodiment.

FIG. 2 is a perspective view showing an outline shape and a position of each of regions constituting the electrolytic water generator shown in FIG. 1.

FIG. 3 is a perspective view specifically showing the structure of the electrolytic water generator shown in FIG. 1.

FIG. 4 is a plan view showing the structure of the electrolytic cell region shown in FIG. 3 viewed from direction A.

FIG. 5 is a plan view showing the structure of the electrolytic cell region shown in FIG. 3 viewed from direction B.

FIG. 6 is a plan view showing the structure of the electrolytic water generator shown in FIG. 1 when one electrolytic cell is unattached or removed because of a breakdown.

FIG. 7 is a plan view for explaining a method for detecting water quality generated in each electrolytic cell of the electrolytic water generator shown in FIG. 1.

### DETAILED DESCRIPTION

In general, according to one embodiment, an electrolytic water generator includes a plurality of electrolytic cells configured to generate electrolytic water by energizing a pair of electrodes arranged in water to be electrolyzed. An inflow unit is configured to let the water to be electrolyzed flow in parallel. An inflow disconnecting unit is configured to individually disconnect the water to be electrolyzed flowing in parallel is provided in the inflow unit. An electrode disconnecting unit is configured to individually disconnect between the pair of electrodes is provided. Power is supplied with a constant current from a power source by connecting the pair of electrodes of the plurality of electrolytic cells in series through the electrode disconnecting unit.

Various embodiments will be described hereinafter with reference to the accompanying drawings.

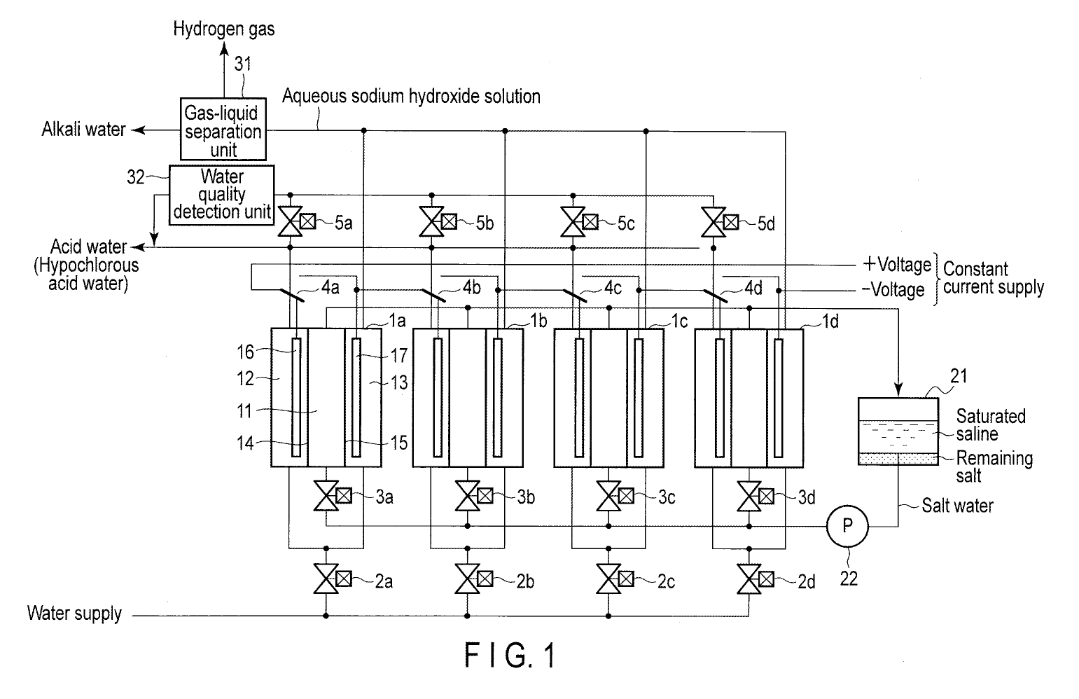

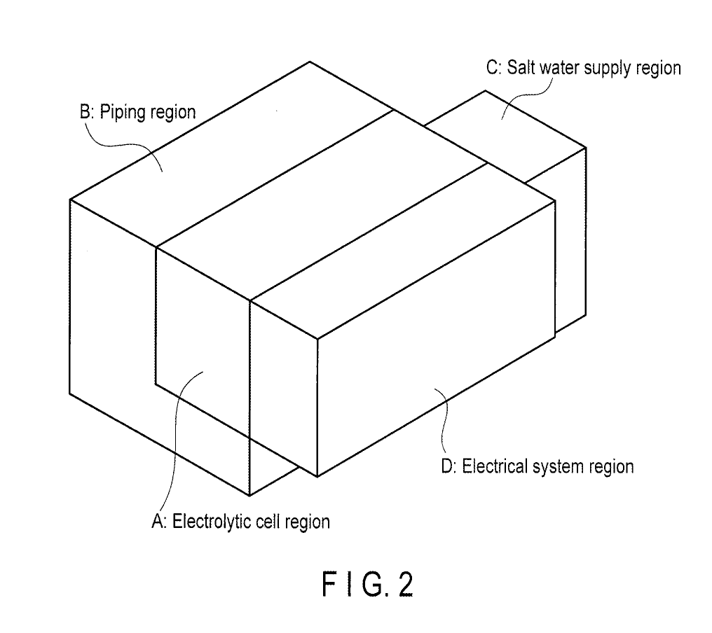

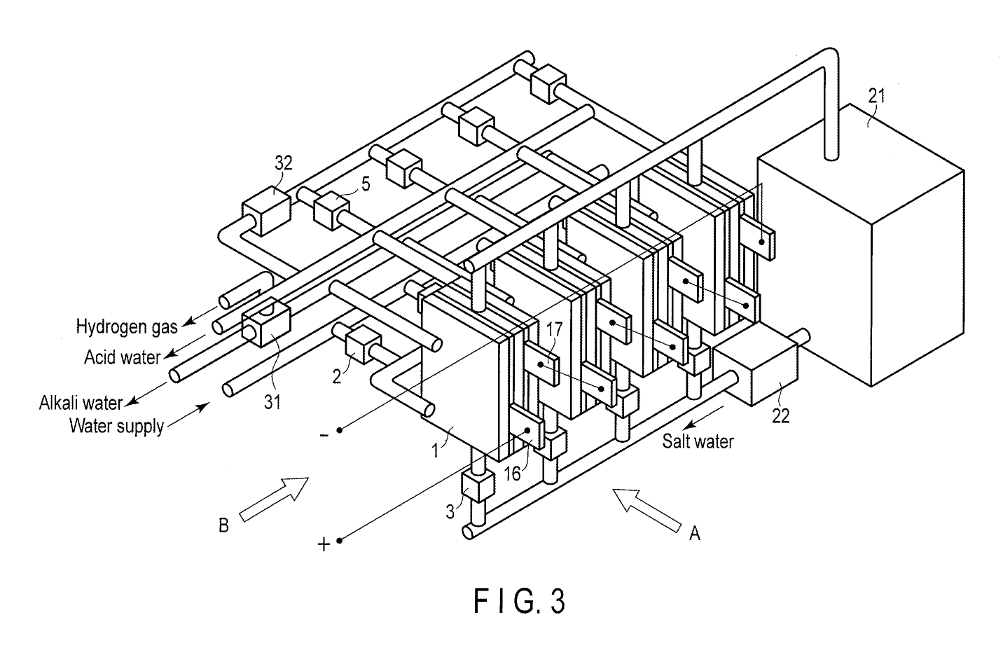

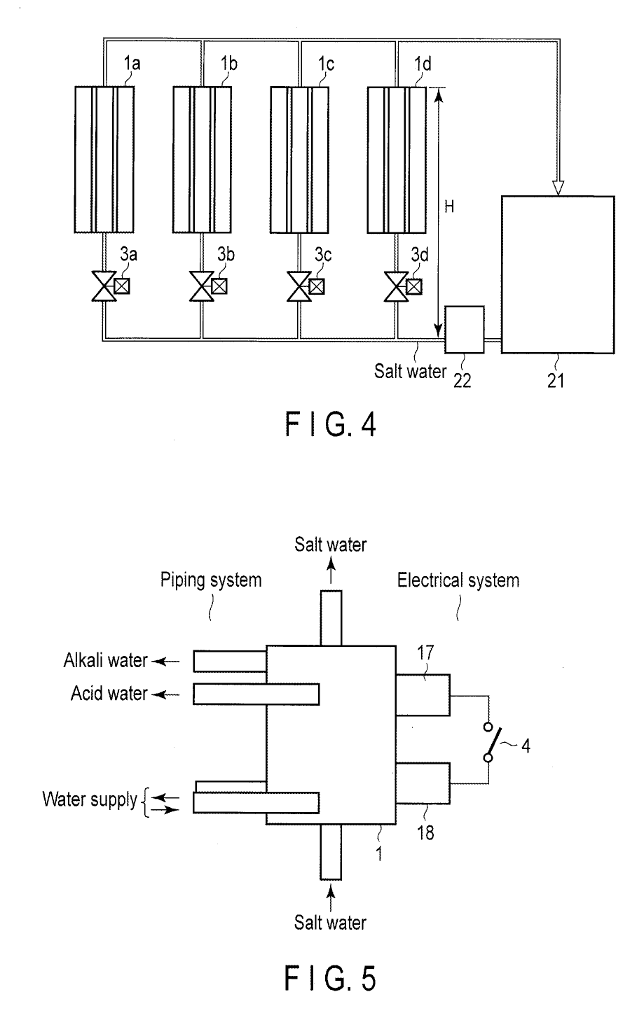

FIG. 1 is a conceptual diagram showing a structure of an electrolytic water generator of an embodiment. FIG. 2 is a perspective view showing structural regions of the electrolytic water generator shown in FIG. 1. FIG. 3 is a perspective view specifically showing the structure shown in FIG. 1. FIG. 4 is a plan view showing the structure of the electrolytic cell region shown in FIG. 3 viewed from direction A. FIG. 5 is a plan view showing the structure of the electrolytic cell region shown in FIG. 3 viewed from direction B.

As shown in FIG. 2, the electrolytic water generator of the present embodiment is roughly classified into an electrolytic cell region A, a piping region B, a salt water supply region C and an electrical system region D. Of these regions, the electrical system region D integrates electrical components such as a control controller and a power source which are not shown in detail. The electrical system region D is partitioned from the other regions to avoid, for example, the influence of water leakage. The electrolytic cell region A includes a plurality of (here, four) electrolytic cells 1 (1a, 1b, 1c and 1d). Each of electrolytic cells 1a, 1b, 1c and 1d has standardized common specifications, and has at least the same outer shape, flow rate and electrolytic capacity. Any of them have a triple-chamber structure placing an anode chamber 12 and a cathode chamber 13 on both sides of a middle chamber 11. The middle chamber 11 and anode chamber 12 are partitioned by an anion exchange membrane 14, and the middle chamber 11 and cathode chamber 13 are partitioned by a cation exchange membrane 15. The anode chamber 12 and the cathode chamber 13 place an anode electrode 16 and a cathode electrode 17, respectively. Water is supplied in parallel to the anode chamber 12 and the cathode chamber 13 through a feed pipe of the piping region B. The water supply to the anode chamber 12 and the cathode chamber 13 of each of electrolytic cells 1a, 1b, 1c and 1d can be individually disconnected by opening and closing control of solenoid valves 2 (2a, 2b, 2c and 2d). The middle chamber 11 of each of electrolytic cells 1a, 1b, 1c and 1d circulates, in parallel, saturated saline generated in a salt water tank 21 of the salt water supply region C using a salt water circulation pump 22. The circulation can be individually disconnected for each electrolytic cell by the opening and closing control of solenoid valves 3 (3a, 3b, 3c and 3d).

The anode electrode 16 and the cathode electrode 17 of each of electrolytic cells 1a, 1b, 1c and 1d are wired to connect each connection end to one constant-current power source (not shown) of the electrical system region D in series, which passes the same current, that is, the same coulomb amount through each of electrolytic cells 1a, 1b, 1c and 1d. Further, a shortcut to be taken can be individually switched between the anode electrode and the cathode electrode of each of electrolytic cells 1a, 1b, 1c and 1d by switches 4 (4a, 4b, 4c and 4d).

When a voltage is applied to saturated saline in electrolytic cells 1a, 1b, 1c and 1d, chlorine ions of the middle chamber 11 enter the anode chamber 12 through the anion exchange membrane 14. As a result, the chlorine ions are oxidized to gaseous chlorine by electrolysis of the anode electrode 16 in the anode chamber 12. Then, the gaseous chlorine dissolves in water, and acid water (here, hypochlorous acid water) is generated. Further, sodium ions of the middle chamber 11 enter the cathode chamber 13 through the cation exchange membrane 15. As a result, gaseous hydrogen is produced from water by electrolysis of the cathode electrode 17 in the cathode chamber 13, and an aqueous alkali solution of sodium (here, aqueous sodium hydroxide solution) is generated. The hypochlorous acid water has a sterilizing function, and the aqueous sodium hydroxide solution has a cleaning function.

The gaseous hydrogen and aqueous sodium hydroxide solution obtained in the cathode chamber 13 of each of electrolytic cells 1a, 1b, 1c and 1d are integrated in piping, and sent to a gas-liquid separation unit 31 in which the aqueous alkali solution is separated from the gaseous hydrogen. Further, the hypochlorous acid water generated in the anode chamber 12 of each of electrolytic cells 1a, 1b, 1c and 1d is integrated in piping and discharged. Further, it selectively flows also to bypass piping including a water quality detection unit 32 by opening and closing solenoid valves 5 (5a, 5b, 5c and 5d). The water quality detection unit 32 detects the quality of water flowing through solenoid valves 5a, 5b, 5c and 5d, such as effective chlorine concentration, pH, oxidation-reduction potential or conductivity of hypochlorous acid water.

An operation and management of the electrolytic water generator according to the above structure will be described below.

Standardized electrolytic cells 1a, 1b, 1c and 1d having the same specifications are provided in parallel in the electrolytic water generator according to the structure. Structural components of electrolytic cells 1a, 1b, 1c and 1d can be shared by making the specifications of electrolytic cells 1a, 1b, 1c and 1d the same in this manner. This allows electrolytic cells 1a, 1b, 1c and 1d to be easily produced and, furthermore, greatly reduces the work of designing individual electrolytic cells. Further, a variety of requests from customers concerning the quantity or quality of electrolytic water can be simply complied with by changing the number of electrolytic cells to be mounted in accordance with the requested quantity or quality of electrolytic water. Further, mounting a plurality of electrolytic cells allows some electrolytic cells to operate even if an electrolytic cell becomes unusable because of, for example, a breakdown. Thus, the unusable electrolytic cell can be replaced while the electrolytic water is generated.

Regarding management of the above embodiment, for example, one electrolytic cell has a capacity of producing 5 liters of hypochlorous acid water per minute from electrolytic water of effective chlorine concentration 60 ppm. In this case, if the electrolytic water generator has the specifications in which the number of electrolytic cells can be selected from one up to four, 5 to 20 liters of hypochlorous acid water per minute can be supported with the water quality of effective chlorine concentration 60 ppm. Further, even if a specific electrolytic cell of a plurality of electrolytic cells is broken, only the broken electrolytic cell can be replaced while the other electrolytic cells operate.

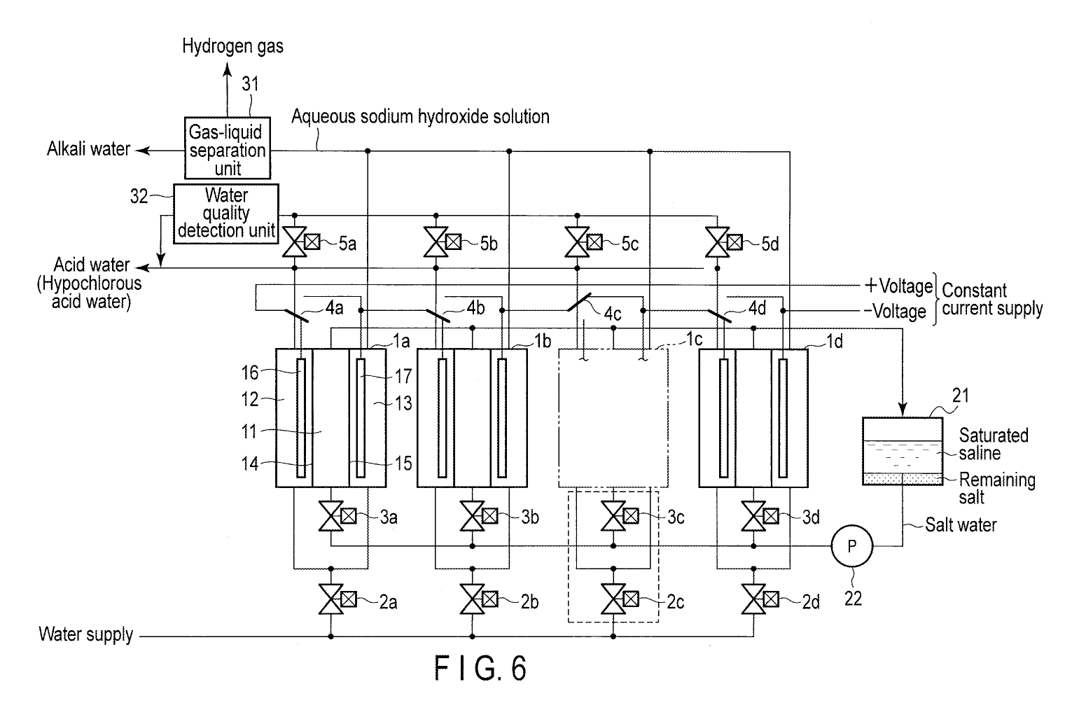

FIG. 6 shows a structure of the electrolytic water generator according to the present embodiment when only electrolytic cell 1c is unattached or when the operation of electrolytic cell 1c stops because of breakdown. If electrolytic cell 1c is unattached or has broken down, solenoid valves 2c and 3c (solenoid valves enclosed with the dotted frame in the figure) are closed, and water supply and circulation of salt water stop. At the same time, the electrodes of electrolytic cell 1c are bypassed using switch 4c, and a current supply circuit to each of electrolytic cells 1a, 1b and 1d is maintained to control power applied to each of electrolytic cells 1a, 1b and 1d to be a constant current. That is, even if electrolytic cell 1c is bypassed, a total voltage decreases only for the voltage of electrolytic cell 1c, and the currents passing through other electrolytic cells 1a, 1b and 1d are made constant. This allows other electrolytic cells 1a, 1b and 1d to operate normally when electrolytic cell 1c is unattached or has broken down.

A check valve or an auxiliary solenoid valve not shown is timely placed in each pipe to prevent unnecessary reverse flow. The check valve or auxiliary solenoid valve is configured to prevent reverse flow from the side of the acid water piping to the side of electrolytic cell 1c if, for example, electrolytic cell 1c is unattached or has broken down.

As described above, in the present embodiment, the plurality of electrolytic cells are mounted in the electrolytic water generator. Feed-water piping is connected in parallel in each electrolytic cell. A solenoid valve is placed for each electrolytic cell. Series electrical interconnection is made to place a group of switches for bypass for each electrolytic cell. Accordingly, even if a specific electrolytic cell is unmounted or broken, the other electrolytic cells can normally operate. Further, the electrolytic cells can be standardized, and a variety of requests from customers can be simply complied with, thereby reducing a risk that an entire device stops in an unexpected state.

Further, the following improvements are desirably achieved to more surely exhibit the above-described effects.

First, each electrolytic cell desirably operates with the same flow rate and the same electrolytic current. Specifically, the size of the electrode, the volume in the electrolytic cell, etc., are made the same. Further, not only the design specifications of the electrolytic cell but also the shapes and materials of components are desirably made the same in terms of component procurement. That is, electrolytic cells having exactly the same specifications are desirably mounted. Then, not only the design specifications of the electrolytic cells but also the components can be shared.

Further, as shown in FIGS. 2 and 5, the electrical system of electrolytic cell 1 is desirably separated from the piping system of electrolytic cell 1. Specifically, it is desirable that the terminals of electrodes 16 and 17 for electrolysis be pulled toward a side of electrolytic cell 1, and the piping be pulled in another direction, preferably, in the opposite direction. This can simplify the entire structure of the device by compactly organizing the electrical system and the piping system, and improve tolerance to water leakage.

Further, as shown in FIG. 4, electrolytic cells 1a, 1b, 1c and 1d are desirably placed to be equal in height of the bottom in order to make equivalent influence on the gravity of water quantity and water pressure. This is important to prevent the electrolytic cells from individually varying in salt water circulation. Variations can be reduced by setting electrolytic cells 1a, 1b, 1c and 1d of the common specifications having at least the same flow rate and the same electrolytic capacity to be equal in height H relative to the salt water circulation pump 22. The above common specifications have desirably the same outer shape.

Further, it is desirable that the plurality of electrolytic cells 1a, 1b, 1c and 1d be substantially rectangular, and be compactly arranged by facing sides having a comparatively large area of a plurality of sides, in order to ease the change caused by the piping length from the salt water circulation pump 22 to each of electrolytic cells 1a, 1b, 1c and 1d. This can reduce the difference in the piping length. The same is true of the piping for feedwater or drainage water, as well as that for salt water. Further, if the piping length cannot be ignored, the quantity of salt water or feedwater circulating in each electrolytic cell may be equalized by changing a diameter of each pipe or by adding components for restricting the flow rate.

Further, the salt water circulation pump 22 is desirably controlled by an inverter to adjust the quantity of circulating salt water in proportion to the number of electrolytic cells in operation.

Further, electrolytic cells 1a, 1b, 1c and 1d are desirably laid out such that their planar portions face each other and electrodes 16 and 17 appear on the same side. The layout increases mounting density to easily perform a replacing operation, and simplifies electric interconnection to easily provide a waterproof structure.

Further, if a manifold is applied to piping connecting to electrolytic cells 1a, 1b, 1c and 1d, manifold components can be made smaller by placing the electrolytic cells near each other.

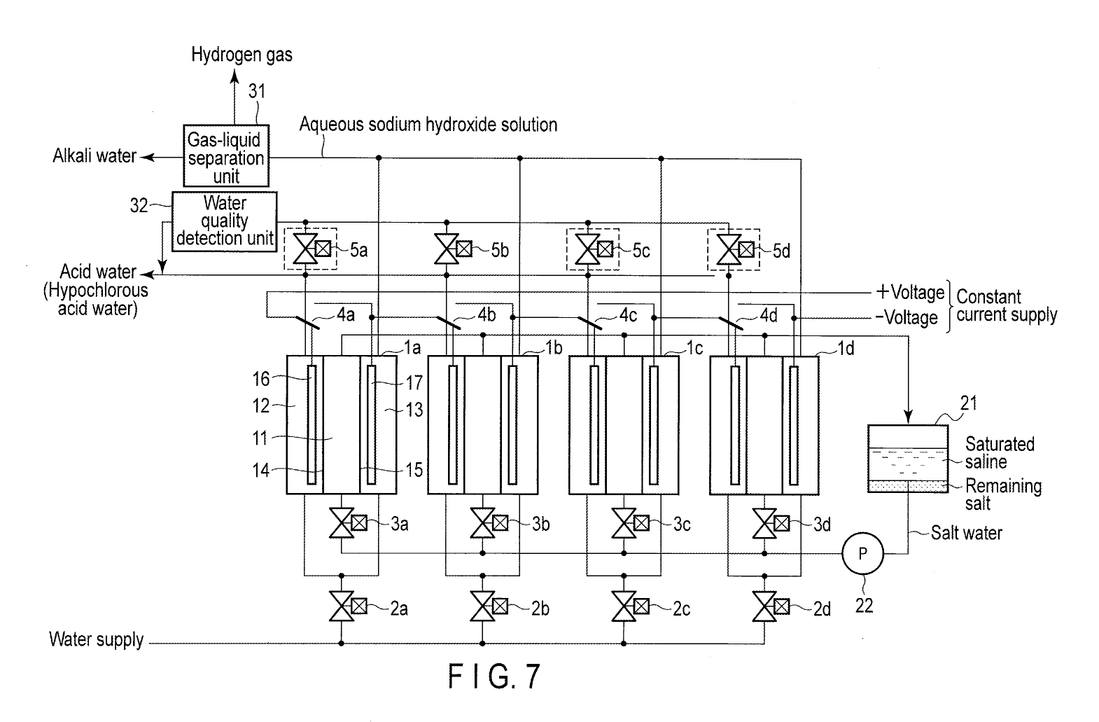

FIG. 7 shows a method for detecting water quality of only hypochlorous acid water generated in electrolytic cell 1b by one water quality detection unit 32. The piping for discharging hypochlorous acid water of each of electrolytic cells 1a, 1b, 1c and 1d includes bypass piping connecting to the water quality detection unit 32 through solenoid valves 5a, 5b, 5c and 5d. In FIG. 7, the solenoid valves other than solenoid valve 5b, that is, solenoid valves 5a, 5c and 5d (solenoid valves enclosed with the dotted frame in the figure) are closed, and only the hypochlorous acid water generated in electrolytic cell 1b flows into the water quality detection unit 32. By placing solenoid valves 5a, 5b, 5c and 5d in the bypass piping connecting to the water quality detection unit 32 to cause the hypochlorous acid water obtained in each of electrolytic cells 1a, 1b, 1c and 1d to selectively flow in this manner, only one water quality detector, which is expensive, can be required. In addition, the quality of water individually generated in each of electrolytic cells 1a, 1b, 1c and 1d can be detected by opening and closing the solenoid valve, and the average quality of water generated in all of the plurality of electrolytic cells can be detected.

Although a triple-chamber electrolytic cell is described in the above embodiment, the structure including the plurality of electrolytic cells of the above embodiment may be applied to a double- or single-chamber electrolytic cell. Further, although hypochlorous acid water is generated in the embodiment, the type of electrolytic water is not limited to the hypochlorous acid water. It may be other electrolytic water.

Further, the electrolytic water generated in the plurality of electrolytic cells may be collectively or individually extracted from each electrolytic cell. That is, an extraction tube is not necessarily provided in all the electrolytic cells. The electrolytic water may be adjusted in accordance with a requested flow rate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrolytic water generator comprising:
a plurality of electrolytic cells configured to generate electrolytic water by energizing a pair of electrodes arranged in water to be electrolyzed;
an inflow unit configured to let the water to be electrolyzed to flow into the plurality of electrolytic cells in parallel;
an inflow disconnecting unit configured to individually disconnect water to be electrolyzed flowing into the plurality of electrolytic cells in parallel;
an electrode disconnecting unit configured to individually disconnect between the pair of electrodes of the plurality of electrolytic cells; and
a power supply unit configured to supply power with a constant current by connecting the pair of electrodes of the plurality of electrolytic cells in series through the electrode disconnecting unit.

2. The electrolytic water generator of claim 1, further comprising:
an extracting unit configured to extract electrolytic water generated in the plurality of electrolytic cells;
a bypass unit configured to bypass electrolytic water extracted in the extracting unit;
a water quality detector configured to detect water quality by letting electrolytic water bypassed in the bypass unit flow;
an electrolytic water disconnecting unit configured to individually disconnect electrolytic water flowing from the plurality of electrolytic cells into the bypass unit.

3. The electrolytic water generator of claim 1, wherein the plurality of electrolytic cells include common specifications with respect to at least a flow rate and an electrolytic capacity.

4. The electrolytic water generator of claim 1, wherein the plurality of electrolytic cells are placed to be equal in height of a bottom.

5. The electrolytic water generator of claim 1, wherein the plurality of electrolytic cells are substantially rectangular, and placed by facing sides including a comparatively large area of a plurality of sides.

6. The electrolytic water generator of claim 1, wherein the pair of electrodes of the plurality of electrolytic cells are provided such that each of terminals is projected from a same side of the plurality of electrolytic cells.

7. The electrolytic water generator of claim 1, wherein each of the plurality of electrolytic cells, which includes a triple-chamber structure, comprises a middle chamber configured to let water to be electrolyzed flow, an anode chamber that stores an anode side of the pair of electrodes through a first ion-exchange membrane on a first side of the middle chamber and is configured to acidify water, and a cathode chamber that stores a cathode side of the pair of electrodes through a second ion-exchange membrane on a second side of the middle chamber and is configured to alkalify water.

8. The electrolytic water generator of claim 7, wherein the inflow unit comprises a circulation unit configured to circulate the water to be electrolyzed in the middle chamber of each of the plurality of electrolytic cells.

9. The electrolytic water generator of claim 7, wherein the inflow unit comprises a water supply unit configured to supply water in parallel to the anode chamber and the cathode chamber of each of the plurality of electrolytic cells.

10. The electrolytic water generator of claim 7, further comprising a first extraction tube configured to extract the acidified water from the anode chamber of each of the plurality of electrolytic cells, and a second extraction tube configured to extract the alkalified water from the cathode chamber of each of the plurality of electrolytic cells.

11. The electrolytic water generator of claim 10, further comprising a gas-liquid separation unit provided in a middle of at least one of the first and second extraction tubes, and configured to separate a gas from extracted water and to output the gas.

12. The electrolytic water generator of claim 1, wherein the inflow unit comprises a controller that variably controls a flow rate of the water to be electrolyzed, and is configured to control the flow rate in proportion to a number of electrolytic cells in operation.

13. A method for generating electrolytic water and an electrolytic cell, the method comprising:
providing in parallel a plurality of electrolytic cells configured to generate electrolytic water by energizing a pair of electrodes arranged in water to be electrolyzed;
letting the water to be electrolyzed to flow into the plurality of electrolytic cells in parallel; and
supplying power with a constant current by connecting the pair of electrodes of the plurality of electrolytic cells in series,
wherein an arbitrary electrolytic cell of the plurality of electrolytic cells is individually driven or stopped by individually disconnecting water to be electrolyzed flowing into the plurality of electrolytic cells in parallel, and by individually disconnecting between the pair of electrodes of the plurality of electrolytic cells.

14. Electrolytic water generated by the electrolytic water generating method of claim 13.
